(19) United States
(12) Patent Application Publication
(10) Pub. No.: US 2003/0117423 A1
(43) Pub. Date: Jun. 26, 2003

(54) Color flat panel display sub-pixel arrangements and layouts with reduced blue luminance well visibility

(76) Inventors: Candice Hellen Brown Elliott, Vallejo, CA (US); Thomas Lloyd Credelle, Morgan Hill, CA (US); Moon Hwan Im, Santa Rosa, CA (US)

Correspondence Address: Finnegan, Henderson, Farabow,, Garrett & Dunner, L.L.P., 1300 I Street, N.W., Washington, DC, 20005-3315, US

(21) Appl. No.: 10/278,328

(22) Filed: Oct. 22, 2002

Related U.S. Application Data
(63) Continuation-in-part of application No. 10/024,326, filed on Dec. 14, 2001.

(51) Int. Cl. G09G 5/10

(52) U.S. Cl. 345/690

(57) ABSTRACT

Various embodiments of three-color sub-pixel arrangements and architectures for display and the like are herein disclosed.

### RELATED APPLICATIONS

This application is a continuation-in-part of U.S. patent application Ser. No. 10/024,326 (“the '326 application”), entitled “IMPROVEMENTS TO COLOR FLAT PANEL DISPLAY SUB-PIXEL ARRANGEMENTS AND LAYOUTS,” filed on Dec. 14, 2001, which is hereby incorporated herein by reference.

This application is also related to U.S. patent application Ser. No.______, entitled “COLOR DISPLAY HAVING HORIZONTAL SUB-PIXEL ARRANGEMENTS AND LAYOUTS,” filed on______; U.S. patent application Ser. No.______, entitled “IMPROVEMENTS TO COLOR FLAT PANEL DISPLAY SUB-PIXEL ARRANGEMENTS AND LAYOUTS FOR SUB-PIXEL RENDERING WITH INCREASED MODULATION TRANSFER FUNCTION RESPONSE,” filed on______; and U.S. patent application Ser. No. ______, entitled “IMPROVEMENTS TO COLOR FLAT PANEL DISPLAY SUB-PIXEL ARRANGEMENTS AND LAYOUTS FOR SUB-PIXEL RENDERING WITH SPLIT BLUE SUBPIXELS,” filed on______, which are all hereby incorporated herein by reference and commonly owned by the same assignee of this application.

### BACKGROUND

The present application relates to improvements to display layouts, and, more particularly, to improved color pixel arrangements and means of addressing used in displays.

The present state of the art of color single plane imaging matrix, for flat panel displays use the red-green-blue (RGB) color triad or a single color in a vertical stripe (i.e. “RGB stripe”) as shown in prior art FIG. 1. FIG. 1 shows a prior art arrangement 10 having several three-color pixel elements with red emitters (or sub-pixels) 14, blue emitters 16, and green emitters 12. The arrangement takes advantage of the Von Bezold effect by separating the three colors and placing equal spatial frequency weight on each color. However, this panel suffers because of inadequate attention to how human vision operates. These types of panels are a poor match to human vision.

Full color perception is produced in the eye by three-color receptor nerve cell types called cones. The three types are sensitive to different wavelengths of light: long, medium, and short (“red”, “green”, and “blue”, respectively). The relative density of the three differs significantly from one another. There are slightly more red receptors than green receptors. There are very few blue receptors compared to red or green receptors.

The human vision system processes the information detected by the eye in several perceptual channels: luminance, chromanance, and motion. Motion is only important for flicker threshold to the imaging system designer. The luminance channel takes the input from only the red and green receptors. In other words, the luminance channel is “color blind”. It processes the information in such a manner that the contrast of edges is enhanced. The chromanance channel does not have edge contrast enhancement. Since the luminance channel uses and enhances every red and green receptor, the resolution of the luminance channel is several times higher than the chromanance channels. Consequently, the blue receptor contribution to luminance perception is negligible. The luminance channel thus acts as a resolution band pass filter. Its peak response is at 35 cycles per degree (cycles/°). It limits the response at 0 cycles/° and at 50 cycles/° in the horizontal and vertical axis. This means that the luminance channel can only tell the relative brightness between two areas within the field of view. It cannot tell the absolute brightness. Further, if any detail is finer than 50 cycles/°, it simply blends together. The limit in the diagonal axes is significantly lower.

The chromanance channel is further subdivided into two sub-channels, to allow us to see full color. These channels are quite different from the luminance channel, acting as low pass filters. One can always tell what color an object is, no matter how big it is in our field of view. The red/green chromanance sub-channel resolution limit is at 8 cycles/°, while the yellow/blue chromanance sub-channel resolution limit is at 4 cycles/°. Thus, the error introduced by lowering the blue resolution by one octave will be barely noticeable by the most perceptive viewer, if at all, as experiments at Xerox and NASA, Ames Research Center (see, e.g., R. Martin, J. Gille, J. Larimer, Detectability of Reduced Blue Pixel Count in Projection Displays, SID Digest 1993) have demonstrated.

The luminance channel determines image details by analyzing the spatial frequency Fourier transform components. From signal theory, any given signal can be represented as the summation of a series of sine waves of varying amplitude and frequency. The process of teasing out, mathematically, these sine-wave-components of a given signal is called a Fourier Transform. The human vision system responds to these sine-wave-components in the two-dimensional image signal.

Color perception is influenced by a process called “assimilation” or the Von Bezold color blending effect. This is what allows separate color pixels (also known as sub-pixels or emitters) of a display to be perceived as a mixed color. This blending effect happens over a given angular distance in the field of view. Because of the relatively scarce blue receptors, this blending happens over a greater angle for blue than for red or green. This distance is approximately 0.25° for blue, while for red or green it is approximately 0.12°. At a viewing distance of twelve inches, 0.25° subtends 50 mils (1,270μ) on a display. Thus, if the blue pixel pitch is less than half (625μ) of this blending pitch, the colors will blend without loss of picture quality. This blending effect is directly related to the chromanance sub-channel resolution limits described above. Below the resolution limit, one sees separate colors, above the resolution limit, one sees the combined color.

Examining the conventional RGB stripe display in prior art FIG. 1, the design assumes that all three colors have the same resolution. The design also assumes that the luminance information and the chromanance information have the same spatial resolution. Further, keeping in mind that the blue sub-pixel is not perceived by the human luminance channel and is therefore seen as a black dot, and since the blue sub-pixel is aligned in stripes, the human viewer sees vertical black lines on the screen as shown in FIG. 2. If the image displayed has large areas of white space, such as when displaying black text on a white background, these dark blue stripes are viewed as a distracting screen artifact. Typical higher resolution prior art displays have pixel densities of 90 pixels per inch. At an average viewing distance of 18 inches, this represents approximately 28 pixels per degree or approximately 14 cycles/°, when showing lines and spaces at the highest Modulation Transfer Function (MTF) allowed by the display. However, what the luminance channel sees is an approximately 28 cycles/° signal horizontally across a white image when considering that the blue sub-pixel 12 is dark compared to the red 14 and green 16 emitters, as shown in prior art FIG. 2. This 28 cycles/° artifact is closer to the peak luminance channel response spatial frequency, 35 cycles/°, than the desired image signal, 14 cycles/°, thus competing for the viewer's attention.

Thus, the above prior artarrangement of three-color emitters is a poor match for human vision.

### BRIEF DESCRIPTION OF THE DRAWINGS

The accompanying drawings, which are incorporated in, and constitute a part of this specification illustrate various implementations and embodiments of the invention and, together with the description, server to explain principles of the invention.

FIG. 1 illustrates a prior art RGB stripe arrangement of three-color pixel elements in an array for a display device.

FIG. 2 illustrates a prior art RGB stripe arrangement as it would be perceived by the luminance channel of the human vision system when a full white image is displayed.

FIG. 3 illustrates an arrangement of three-color pixel elements in an array for a display device.

FIG. 4 illustrates the arrangement of FIG. 3, as the luminance channel of the human vision system would perceive it when a full white image is displayed.

FIG. 5 illustrates a layout of drive lines and transistors for the arrangement of pixel elements of FIG. 4.

FIG. 6 illustrates the arrangement of FIG. 5, as it would be perceived by the luminance channel of the human vision system, when a full white image is displayed.

FIG. 7A shows an arrangement similar to that of FIG. 1 with extra space between the red and green stripes.

FIG. 7B illustrates the arrangement of FIG. 7A, as it would be perceived by the luminance channel of the human vision system, when a full white image is displayed.

FIG. 7C shows an arrangement similar to that of FIG. 1 with the red and green sub-pixels arrayed on a “checkerboard” pattern.

FIG. 7D shows the arrangement of FIG. 7C wherein an additional dark spacing is placed between the two columns having red and the green sub-pixels.

FIG. 8A shows an arrangement of three-color pixel elements in an array for a display device.

FIG. 8B illustrates the arrangement of FIG. 8A, as it would be perceived by the luminance channel of the human vision system, when a full white image is displayed.

FIG. 8C shows an arrangement of three-color pixel elements in an array, in a single plane, for a display device, similar to the arrangement of FIG. 8A, but the elements are rotated 90°.

FIG. 8D illustrates the arrangement of FIG. 8C, as it would be perceived by the luminance channel of the human vision system, when a full white image is displayed.

FIG. 9A shows an arrangement similar to that of FIG. 8A with extra space between the red and green stripes.

FIG. 9B illustrates the arrangement of FIG. 9A, as it would be perceived by the luminance channel of the human vision system, when a full white image is displayed.

FIG. 10A shows an arrangement of three-color pixel elements in an array, in a single plane, for a display device.

FIG. 10B illustrates the arrangement of FIG. 10A, as it would be perceived by the luminance channel of the human vision system, when a full white image is displayed.

FIG. 11A shows an arrangement of three-color pixel elements in an array, in a single plane, for a display device.

FIG. 11B illustrates the arrangement of FIG. 11A, as it would be perceived by the luminance channel of the human vision system, when a full white image is displayed.

FIG. 12A shows an arrangement of three-color pixel elements in an array, in a single plane, for a display device, designed for transflective operation.

FIG. 12B illustrates the arrangement of FIG. 12A, as it would be perceived by the luminance channel of the human vision system, when a full white image is displayed, using a backlight to illuminate the screen under low ambient light conditions.

FIG. 13A shows an arrangement of three-color pixel elements in an array, in a single plane, for a display device.

FIG. 13B illustrates the arrangement of FIG. 13A, as it would be perceived by the luminance channel of the human vision system, when a full white image is displayed.

FIG. 14A shows an arrangement of three-color pixel elements in an array, in a single plane, for a display device.

FIG. 14B illustrates the arrangement of FIG. 14A, as it would be perceived by the luminance channel of the human vision system, when a full white image is displayed.

### DETAILED DESCRIPTION

Reference will now be made in detail to various implementations and embodiments, examples of which are illustrated in the accompanying drawings. Wherever possible, the same reference numbers will be used throughout the drawings to refer to the same or like parts.

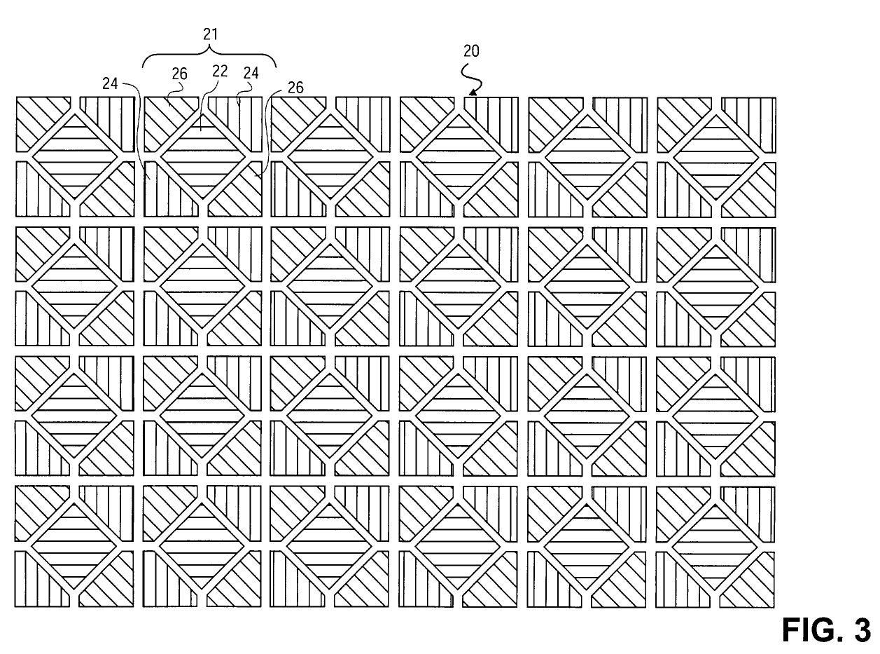

As described in the '326 application as well as in co-pending and commonly assigned U.S. patent application Ser. No. 09/916,232 (“the '232 application”), entitled “ARRANGEMENT OF COLOR PIXELS FOR FULL COLOR IMAGING DEVICES WITH SIMPLIFIED ADDRESSING”, filed on Jul. 25, 2001, which is hereby incorporated herein by reference and commonly owned by the same assignee of this application, FIG. 3 illustrates an arrangement 20 of several three-color pixel elements according to one embodiment. A three-color pixel element 21 consists of a blue emitter (or sub-pixel) 22, two red emitters 24, and two green emitters 26 in a square, which is described as follows. The three-color pixel element 21 is square shaped and is centered at the origin of an X, Y coordinate system. The blue emitter 22 is centered at the origin of the square and extends into the first, second, third, and fourth quadrants of the X, Y coordinate system. A pair of red emitters 24 is disposed in opposing quadrants (i.e., the second and the fourth quadrants), and a pair of green emitters 26 is disposed in opposing quadrants (i.e., the first and the third quadrants), occupying the portions of the quadrants not occupied by the blue emitter 22. The pair of red emitters 24 and green emitters 26 can also be disposed in the first and third quadrants and the second and fourth quadrants, respectively. As shown in FIG. 3, the blue emitter 22 can be square-shaped; having corners aligned at the X and Y axes of the coordinate system, and the opposing pairs of red 24 and green 26 emitters can be generally square shaped (or triangular shaped), having truncated inwardly-facing corners forming edges parallel to the sides of the blue emitter 22.

The array is repeated across a panel to complete a device with a desired matrix resolution. The repeating three-color pixels form a “checker board” of alternating red 24 and green 26 emitters with blue emitters 22 distributed evenly across the device. However, in such an arrangement, the blue emitters 22 are at half the resolution of the red 24 and green 26 emitters.

One advantage of such a three-color pixel element array is improved resolution of color displays. This occurs since only the red and green emitters contribute significantly to the perception of high resolution in the luminance channel. Thus, reducing the number of blue emitters and replacing some with red and green emitters improves resolution by more closely matching human vision.

Dividing the red and green emitters in half in the vertical axis to increase spatial addressability is an improvement over the conventional vertical single color stripe of the prior art. An alternating “checkerboard” of red and green emitters allows the Modulation Transfer Function (MTF), i.e. high spatial frequency resolution, to increase in both the horizontal and the vertical axes as was disclosed in the '232 application, using sub-pixel rendering techniques such as that described in co-pending and commonly assigned U.S. patent application Ser. No. 10/150,355, (“the '355 application”), entitled “METHODS AND SYSTEMS FOR SUB-PIXEL RENDERING WITH GAMMA ADJUSTMENT,” filed on May 17, 2002, which is hereby incorporated herein by reference. A further advantage of this arrangement over the prior art arrangement is the shape and location of the blue emitter.

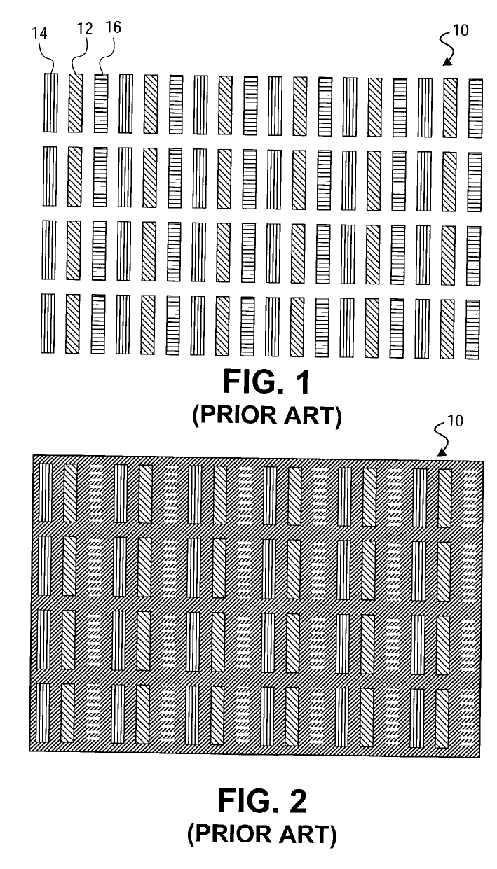

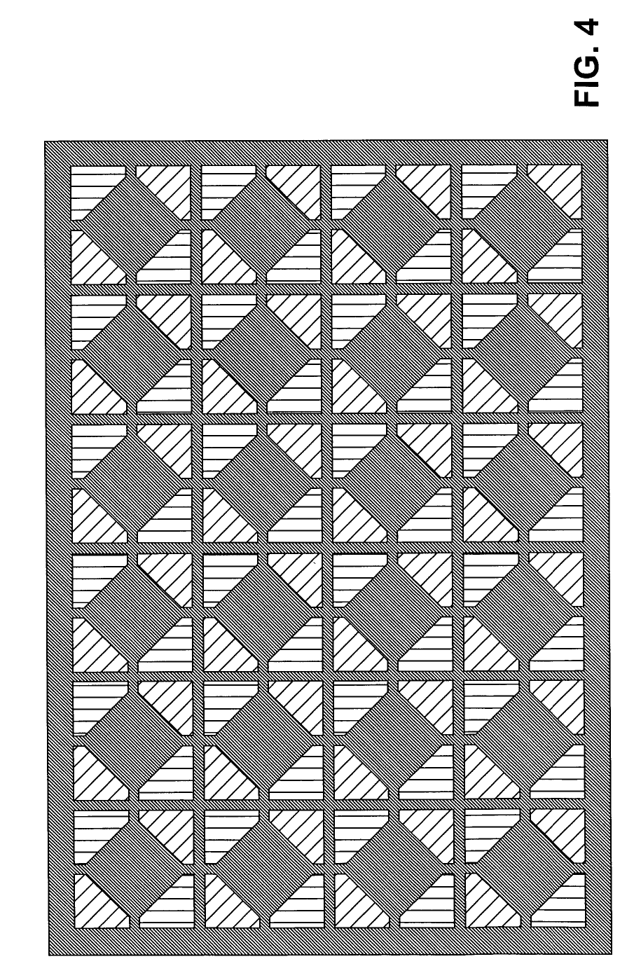

In the prior art arrangement of FIG. 1, the blue emitters are viewed in stripes. That is, when viewed, the luminance channel of the human vision system sees these blue emitters as black stripes alternating with white stripes, as illustrated in prior art FIG. 2. In the horizontal direction, there are faint, but discernable lines between rows of three-color pixel elements, largely due to the presence of the transistors, and/or associated structures, such as capacitors, at each emitter, as is common in the art. However, with the arrangement of FIG. 3, when viewed, the luminance channel of the human vision system sees black dots alternating with white dots as illustrated in FIG. 4. This is an improvement because the spatial frequency, i.e. Fourier Transform wave component, and the energies of these components are now spread into every axis, vertical, diagonal, as well as horizontal, reducing the amplitude of the original horizontal signal, and thus, the visual response (i.e., visibility).

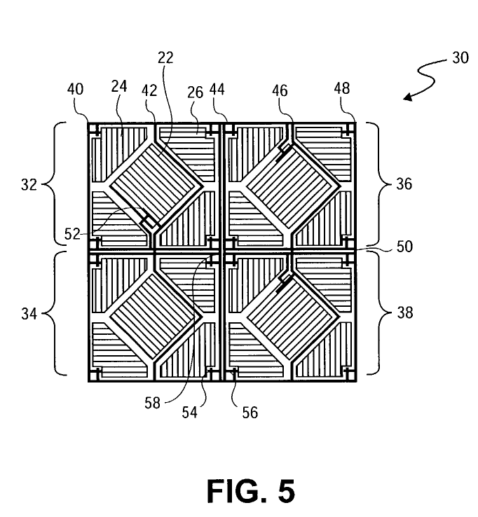

FIG. 5 illustrates an embodiment wherein only four three-color pixel elements 32, 34, 36, and 38 are grouped in arrangement 30, while several thousand can be arranged in an array. Column address drive lines 40, 42, 44, 46, and 48 and row address drive line 50 drive each three color pixel element 32, 34, 36, and 38. Each emitter has a transistor, and possibly associated structures such as a capacitor, which may be a sample/hold transistor/capacitor circuit. Therefore, each blue emitter 22 has a transistor 52, each red emitter 24 has a transistor 54, and each green emitter 26 has a transistor 56. Having two column lines 44 and two row lines 50 allows for the transistors, and/or associated structures, for the red emitters and green emitters to be gathered together into the interstitial comers between the three-color pixel elements 32, 34, 36, and 38 creating combined transistor groups 58

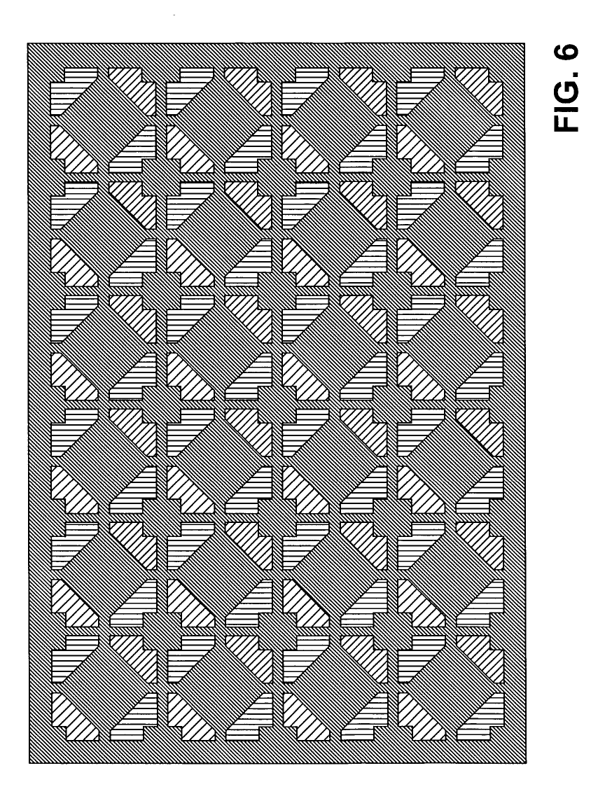

The grouping of the transistors and/or associated structures, such as capacitors, in the interstitial comers appears to be counter to good design practice, t, since collecting them together makes them a bigger, and thus more visible dark spot, as shown in FIG. 6. However, in this circumstance these dark spots are exactly halfway between the blue emitter 22 in each three-color pixel element, which provides a beneficial effect as described below.

For instance, in this embodiment, the spatial frequency of the combined transistor groups and/or associated structures, 58 and the blue emitter 22 is doubled, pushing them above the 50 cycles/° resolution limit of the luminance channel of human vision. For example, in a 90 pixel per inch display panel the blue emitter pitch, without the grouped transistors, would create a 28 cycles/° luminance channel signal, both horizontally and vertically. In other words, the blue emitters may be visible as a texture on solid white areas of a display. However, they will not be as visible as the stripes visible in the prior art arrangement.

In contrast to the prior art arrangement of FIG. 1, with the transistors grouped together, the combined group transistors 58 and the blue emitters 22 both become less visible at 56 cycles/°, virtually vanishing from sight almost entirely. In other words, the grouping of the transistors and the blue emitters combine to produce a texture on solid white areas of a display too fine for the human visual system to see. In using this embodiment, the solid white areas become as smooth looking as a sheet of paper.

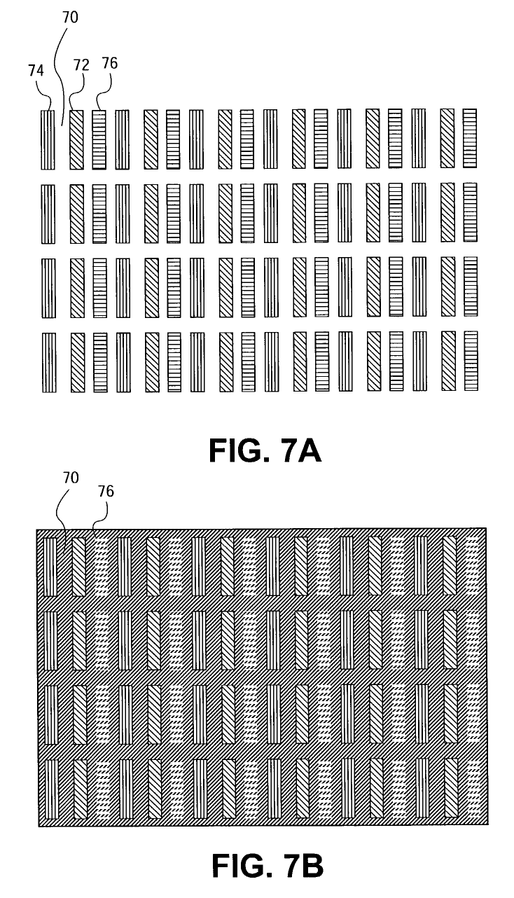

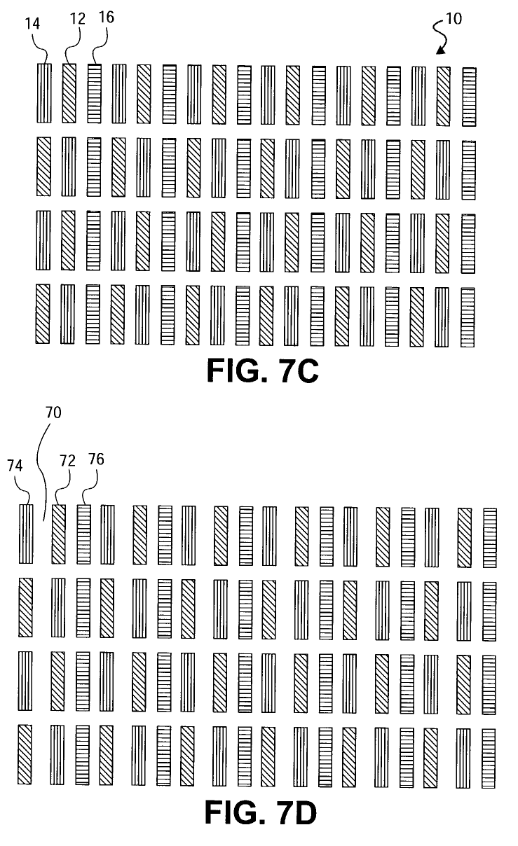

In accordance with another embodiment, FIG. 7A shows an arrangement of three color pixels, three sub-pixels red 74, green 72, and blue 76, repeated in an array to make up an electronic display, similar to that of the prior art arrangement of FIG. 1, except for the extra space 70 that has been inserted between the red 74 and green 72 stripes. The red 74 and green 72 stripes are also interchangeable by interchanging the red 74 and green 72 sub-pixels. As illustrated in FIG. 7B, the luminance channel perceives the blue 76 stripes to be dark stripes that are substantially 180° out of phase with the dark stripes caused by the extra space 70. The extra space 70 creates the same spatial frequency doubling effect as described earlier for the arrangement of FIG. 5. Similarly, the extra space may be disposed where Thin Film Transistors (TFT) and associated storage capacitor elements may be positioned. Additionally, it may be desirable to use ‘black matrix’ material, known in the art, to fill the extra space.

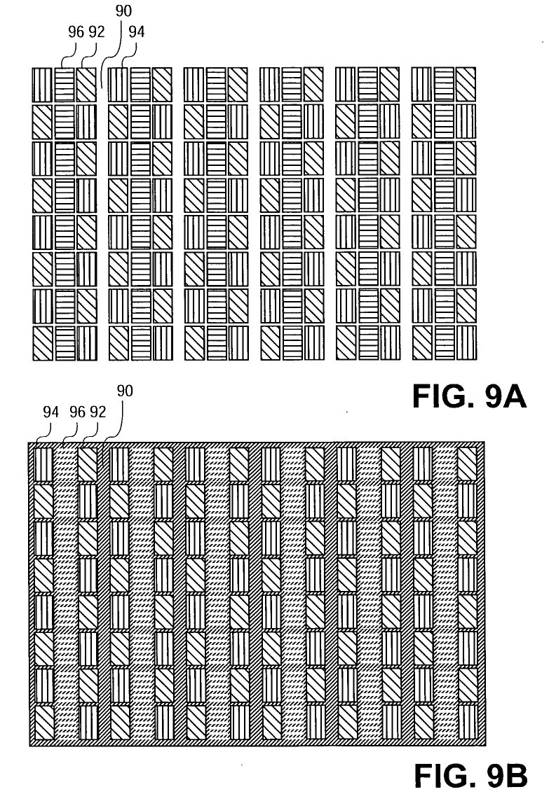

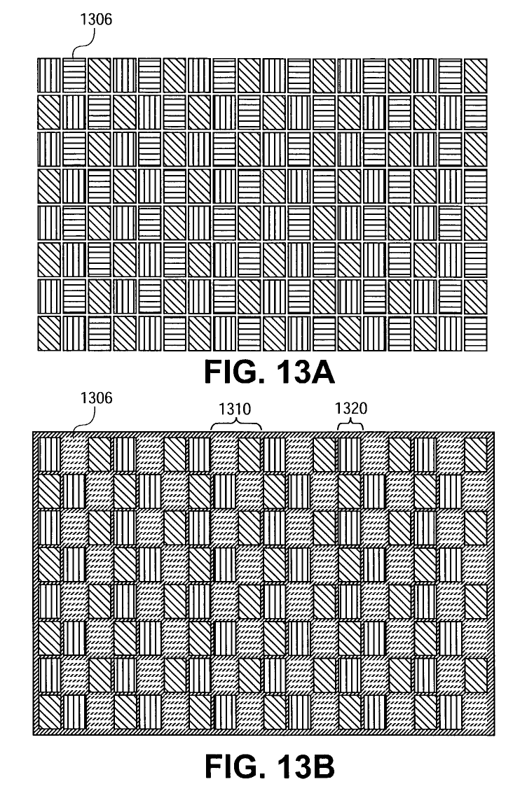

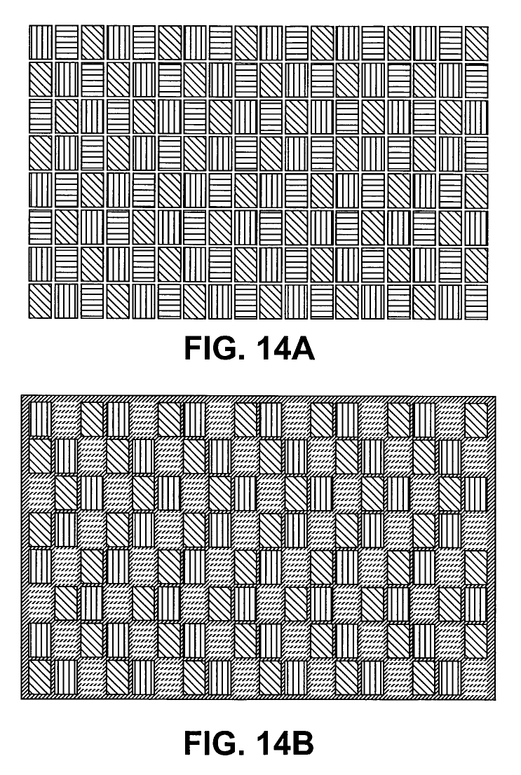

The techniques disclosed herein can apply to any sub-pixel groupings—repeated on a display—wherein some dark colored sub-pixels substantially form a vertical line down the display. Thus, the disclosed techniques not only contemplate configurations such as traditional RGB striping and its improvements and other configuration such as FIG. 9A; but also any repeat sub-pixel grouping that comprises a dark color sub-pixel stripe on the display. Additionally, the disclosed techniques contemplate any color—blue or substantially blue or some other dark color where a vertical stripe would be visible to the eye when fully turned on—might benefit from the addition of such a stripe. Additionally, this dark strip could be used in conjunction with a staggered vertical line—as discussed in connection with FIGS. 13A, 13B, 14A and 14B —and any other configuration wherein the dark colored sub-pixel line is possible staggered and/or scattered. The spacing should be sufficient in all of these cases such that the human eye would perceive the dark colored sub-pixel stripe to be visibly out of phase with the spacing.

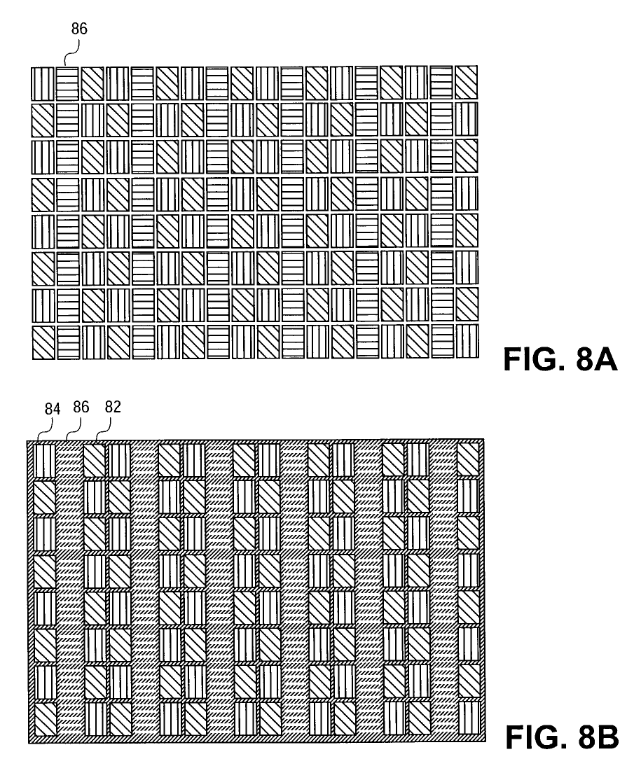

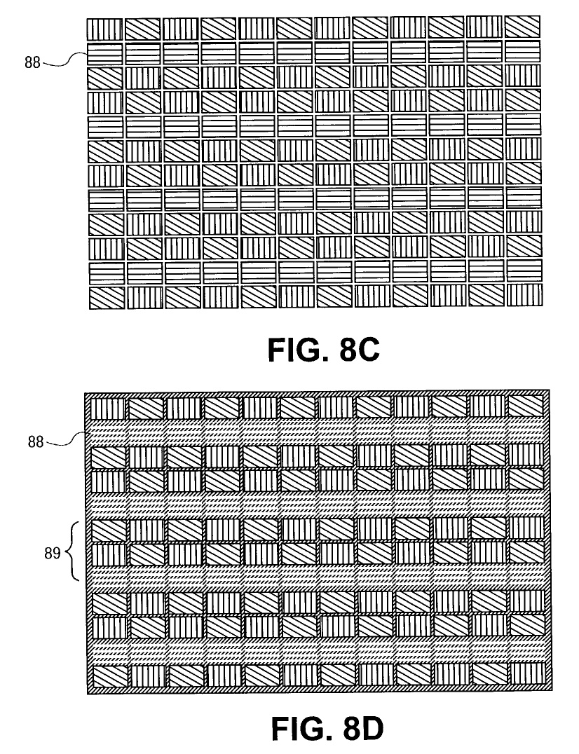

FIG. 7C shows another alternative embodiment wherein the traditional stripe arrangement is altered by changing the color assignments of the red and green sub-pixels on alternating rows—so that the red sub-pixels 74 and green sub-pixels 72 are now on a “checkerboard” pattern. As previously discussed, this checkerboard pattern allows for high spatial frequency to increase in both the horizontal and vertical axes. The installed base of TFT back planes, that conventionally use sub-pixels with a 3:1 aspect ratio, may be used to advantage by redefining the color filter only by swapping the red and green color assignments every other row as shown. The TCON may handle the reordering of the color data to allow for sub-pixel rendering, and sub-pixel rendering may be accomplished in the manner described in the '355 application, or in another suitable manner known in the art. Sub-pixels with a 3:1 (height to width) aspect ratio having a contiguous grouping of a red, green, and a blue sub-pixel within a row may be addressed as a ‘whole pixel’. This whole pixel may be at 1:1 aspect ratio. An array of such whole pixels may be addressed using conventional whole pixel addressing means and methods to allow compatibility and equivalent characteristics as prior art RGB stripe displays, but allow superior sub-pixel rendering performance, when addressed so, due to the red and green checkerboard. This is contrasted with the aspect ratio of 3:2 (height to width) shown in FIG. 8A, described in the '232 application. In that case, a grouping of six sub-pixels, three in one row and three in the next, directly below or above, will collectively exhibit a 1:1 aspect ratio

FIG. 7D shows the arrangement of FIG. 7C wherein an extra space 70 is inserted between the columns having the red and green sub-pixels only. The luminance channel would then perceive the blue stripes 76 to be dark strips that are substantially 180° out of phase with the dark stripe caused by the extra space 70—similar to that shown in FIG. 7B.

FIG. 8A shows an arrangement of three-color sub-pixels as was described in the '232 application. FIG. 8B illustrates how the arrangement of FIG. 8A would be perceived by the luminance channel of the human vision system when a full white image is displayed. Note that the blue 86 sub-pixels form dark stripes against the white background. In this case, since sub-pixel rendering on the red 84 and green 82 checkerboard can show images at the same spatial frequency as the dark blue 86 stripes, the ‘noise’ of the dark blue 86 stripes creates a masking signal that interferes with the desired sub-pixel rendered image.

Since the human vision system has slighter higher sensitivity to contrast modulation in the horizontal direction, rotating the dark blue stripes as shown in FIGS. 8C and 8D may reduce the visibility. Further, since the dark blue stripes 88 and white stripes 89 are in the same plane as the binocular placement of eyes in the human face, the horizontal stripes do not induce a signal in the stereoopsis, depth perception, pathways in the brain, reducing their visibility. A further reduction may be caused by long exposure to horizontal stripes in raster scanned CRTs such as commercial television units creating a well practiced perceptual filter in the human vision system. That is to say, those viewers long accustomed to viewing electronic displays with horizontal stripes simply learn to ignore them. This horizontal arrangement for sub-pixel layout—wherein each said sub-pixel is formed on the display with its length-wise side on the horizontal axis is described in co-pending and commonly assigned U.S. patent application Ser. No.______, entitled “COLOR DISPLAY HAVING HORIZONTAL SUB-PIXEL ARRANGEMENTS AND LAYOUTS,” filed on______.

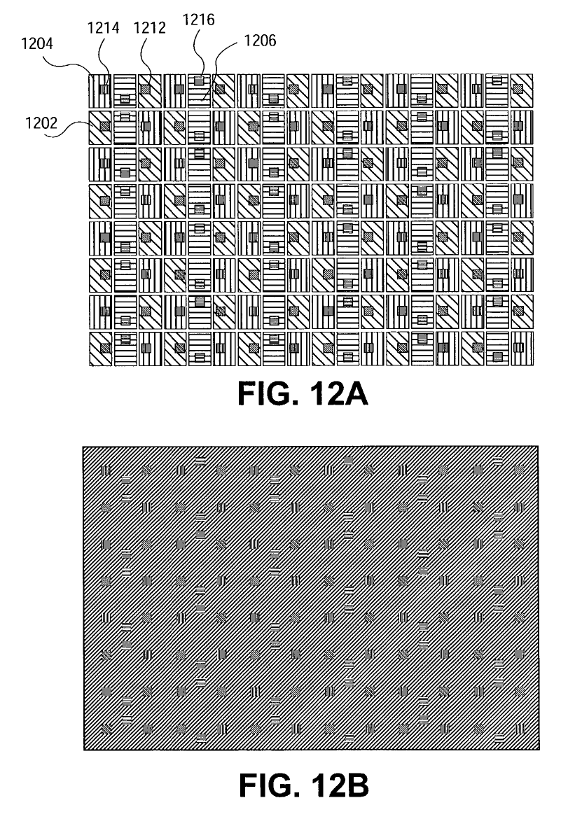

It should be appreciated that more than one of the disclosed techniques can be used simultaneously for additive benefit; For example, stripes 88 and 89 of FIG. 8C may be combined with the extra space 90 described and shown in FIG. 9A, with the transistors and associated storage capacitors creating the space, may be combined with the optimally positioned optical vias described and shown in FIG. 12A, also perhaps with a narrower, but higher luminance, blue sub-pixel.

In accordance with another embodiment, FIG. 9A shows an arrangement similar to that of FIG. 8A, save that extra space 90 has been inserted between the red/green stripes 92 and 94. As illustrated in FIG. 9B, the luminance channel perceives the blue stripes 96 to be dark stripes that are substantially 180° out of phase with the dark stripes caused by the extra space 90. The extra space 90 creates the same spatial frequency doubling effect as described earlier for the arrangement of FIG. 7A. Similarly, the extra space may be where Thin Film Transistors (TFT) and associated storage capacitor elements may be positioned. Additionally, it may be desirable to use ‘black matrix’ material, known in the art, to fill the extra space.

In FIGS. 7A, 7D and 9A, the extra space width is calculated to compensate and double the effective spatial frequency of the blue stripe luminance well. While a first order analysis of the blue stripe is to assume that it has zero luminance because the blue receptors of the eye does not connect to the luminance channel of the human vision system, real embodiments of flat panel displays may not have ideal blue emitters, instead they may be emitting light that is perceived in part by the green receptors which do feed the luminance channel. Thus, a careful analysis of real embodiments of flat panel displays takes into account the slight, but measurable, luminance of the substantially blue emitters. The more luminance the blue emitter has, the narrower the extra space is designed. Also, the more radiance the blue emitter has, the narrower the blue emitter may be and still have the same white balance on the display. This in turn leads to a narrower extra space required to balance the blue stripe. Thus, it may be advantageous to use a backlight and/or blue emitter that has more deep blue emission to allow a narrower blue sub-pixel, and more blue-green emission to increase the luminance and thus allow an even narrower extra space. Calculating the optimum dimensions of the extra space can be accomplished by using a one dimensional model of the display, with each color emitters luminance, applying a Fourier Transform, noting the signal strength of the dark/light variations, adjusting the widths of the extra space vs. the emitters, until the signal strength is minimized.

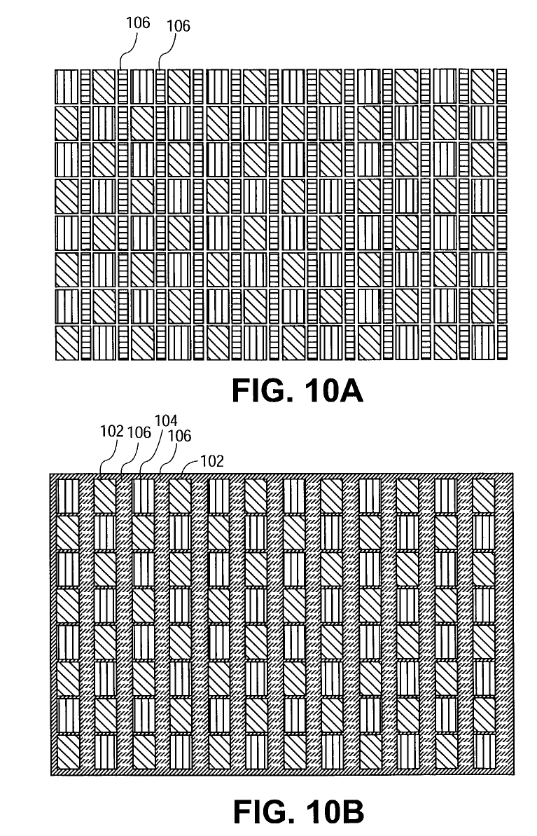

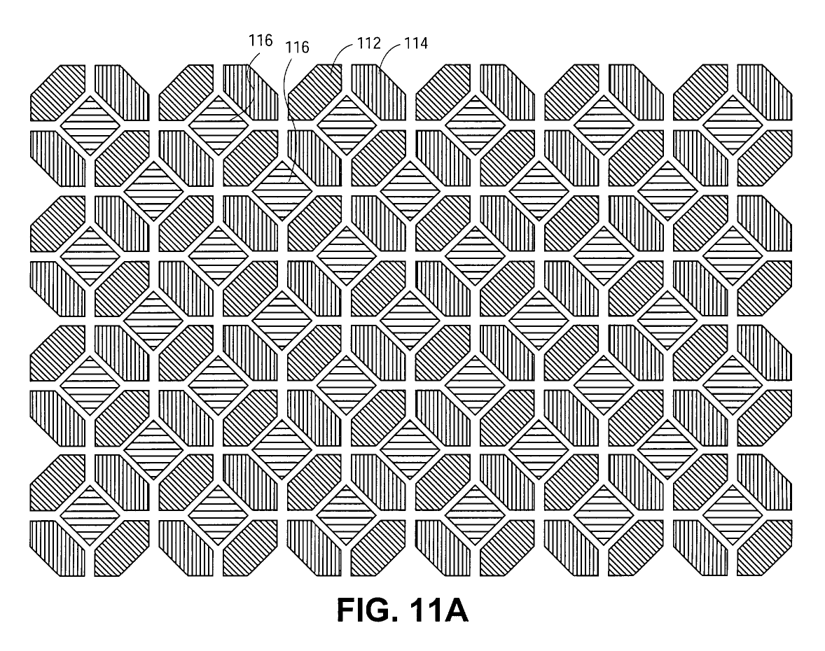

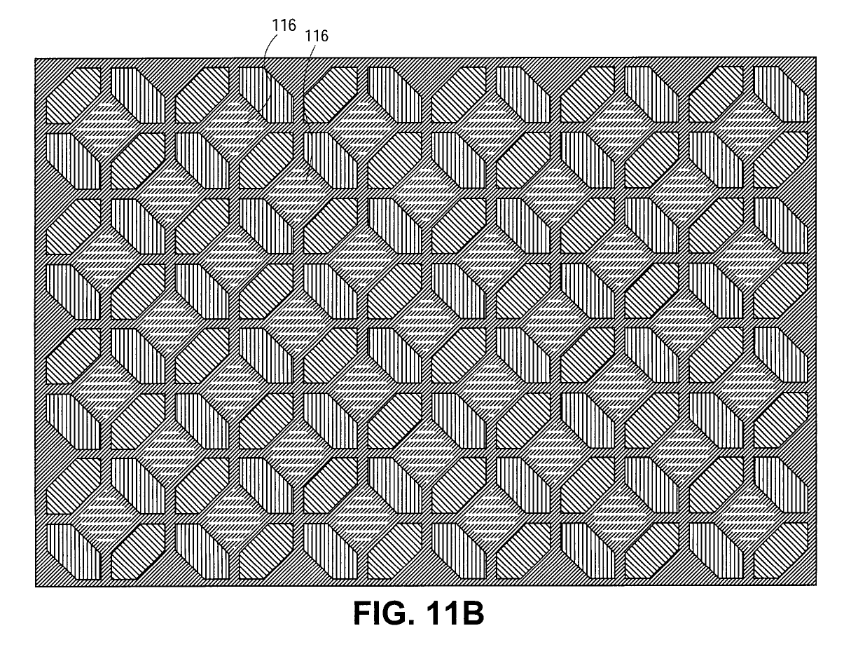

According to another embodiment, instead of creating a black feature on the display panel, it is possible to split the blue sub-pixel to increase the spatial frequency. It may also be desirable to place the split blue sub-pixels evenly across the panel. FIGS. 10A and 11A show such a modification to the arrangements of FIGS. 8A and 3, respectively.

FIG. 10A shows the blue sub-pixel stripe split into two stripes, each half the width along a horizontal axis of the red and green stripes, and placed between each column of red 104 and green 102 alternating sub-pixels. As illustrated in FIG. 10B, the luminance channel perceives the blue 106 stripes to be dark stripes that are substantially 180° out of phase with each other. The extra split blue 106 stripes create the same spatial frequency doubling effect as described earlier for the arrangement of FIG. 9A.

FIG. 11 A shows the blue sub-pixel dots split into two sub-pixel dots, each half the area of the red and green sub-pixels, and placed between each column and row of red 114 and green 112 alternating sub-pixels. As illustrated in FIG. 10B, the luminance channel perceives the blue 116 dots to be dark dots that are substantially 180° out of phase with each other. The extra split blue 116 dots create the same spatial frequency doubling effect as described earlier for the arrangement of FIG. 6.

It should be noted that the above embodiments have the additional benefit of moving the red and green sub-pixels closer to being on a regular, evenly spaced, checkerboard. This improves sub-pixel rendering performance. In accordance with this aspect, FIGS. 12A and 12B show an embodiment for a transflective display that place optical vias 1212, 1214, and 1216 in positions that increase sub-pixel rendering performance and decrease the blue stripe visibility. FIG. 12A uses a similar arrangement of red 1204, green 1202, and blue 1206 sub-pixels as that of FIG. 8A. These sub-pixels reflect ambient light toward the viewer, modulated by the display device incorporated therein. Such a device may be Liquid Crystal or Iridescent in operation, or other suitable technology. During high ambient light conditions, such a display may be perceived by the luminance channel of the human vision system as shown in FIG. 8B. However, during low ambient light conditions, a backlight may illuminate the display, primarily through the red 1214, green 1212, and blue 1216 optical vias. A similar use of optical vias could also be used on the altered RGB stripe display shown in FIG. 7C to similar effect for purposes of the present invention.

FIG. 12B illustrates how the arrangement of FIG. 12A would be perceived by the luminance channel of the human vision system when a full white image is displayed under low ambient light conditions. Note that the red 1214 and green 1212 optical vias are arranged such that they approach being a regular, evenly spaced, checkerboard, improving the sub-pixel rendering performance. Also note that the blue 1216 optical vias are placed such that they break up the stripe appearance, in both horizontal and vertical axis, when they are backlit and viewed under low ambient light conditions. The positioning of the blue 1216 optical vias shifts the phases of the blue reconstruction points, reducing their visibility. While two positions of the optical vias are shown in the illustration, it is to be appreciated that the number of possible positions that they may take is unlimited, and all are contemplated and encompassed by the present invention.

In accordance with this additional aspect of the embodiments, FIGS. 13A, 13B, 14A, and 14B show how shifting the phase of the blue sub-pixels reduces the visibility of the dark luminance wells. FIG. 13A shows an arrangement of sub-pixel based in part on the arrangement of 8A with every other row copied from the one above and shifted by one sub-pixel to the right. This creates an arrangement of blue 1306 sub-pixels that takes two phases out of a three possible phases. FIG. 13B illustrates how the arrangement of FIG. 13A would be perceived by the luminance channel of the human vision system when a full white image is displayed. Note that the dark stripes 1310 have been reduced in amplitude but increased in width, when allowing for some luminance blending, while the white stripes 1320 have been reduced in both amplitude and width. This reduces the Fourier Transform signal energy, and thus the visibility of the stripes.

FIG. 14A shows an arrangement of sub-pixel based in part on the arrangement of 13A with every third row is shifted by one sub-pixel to the right. This creates an arrangement of blue 1306 sub-pixels that takes three phases out of a three possible phases. FIG. 14B illustrates how the arrangement of FIG. 14A would be perceived by the luminance channel of the human vision system when a full white image is displayed. The various phases and angles scatter the Fourier Transform signal energy, and thus reduce the visibility of the blue sub-pixel caused luminance wells.

While the invention has been described with reference to exemplary embodiments, various changes may be made and equivalents may be substituted for elements thereof without departing from the scope of the invention. In addition, many modifications may be made to adapt a particular situation or material to the teachings without departing from the essential scope thereof. For example, some of the embodiments above may be implemented in other display technologies such as Organic Light Emitting Diode (OLED), ElectroLumenscent (EL), Electrophoretic, Active Matrix Liquid Crystal Display (AMLCD), Passive Matrix Liquid Crystal display (AMLCD), Incandescent, solid state Light Emitting Diode (LED), Plasma Display Panel (PDP), and Iridescent. Further, more than one of the disclosed techniques can be used simultaneously for additive benefit; For example, the extra space described and shown in FIG. 9A, with the transistors and associated storage capacitors creating the space, may be combined with the optimally positioned optical vias described and shown in FIG. 12A, also perhaps with a narrower, but higher luminance, blue sub-pixel. Therefore, it is intended that the invention not be limited to any particular embodiment for carrying out this invention.

What is claimed is:

1. A display comprising:
a plurality of sub-pixel groupings, each said sub-pixel grouping further comprising a plurality of color sub-pixels, wherein one of said color sub-pixels is substantially a dark color sub-pixel;
wherein said sub-pixel groupings form an array across said display in a plurality of rows and columns and wherein said dark color sub-pixels form substantially a vertical line down said display; and
wherein a spacing is disposed between adjacent columns of said sub-pixel groupings wherein said spacing forms a dark stripe substantially out of phase with said substantially vertical line of said dark color sub-pixels.

2. The display as recited in claim 1 wherein further said dark color sub-pixel is substantially a blue color sub-pixel.

3. The display as recited in claim 1 wherein said sub-pixel grouping comprises an RGB stripe.

4. The display as recited in claim 1 wherein said sub-pixel grouping comprises a red and green sub-pixel checkerboard pattern.

5. The display as recited in claim 1 further comprisinga black matrix material disposed about said spacing.

6. A RGB stripe display comprising:
a plurality of RGB stripe sub-pixel groupings;
wherein color assignments for the red sub-pixels and the green sub-pixels are switched on alternating rows.

7. The RGB stripe display as recited in claim 6 wherein said red sub-pixels and said green sub-pixels form substantially a checkerboard pattern.

8. The RGB stripe display as recited in claim 6 wherein a spacing is placed between adjacent columns of red and green sub-pixels.

9. The RGB stripe display as recited in claim 8 further comprising a black matrix material disposed about said spacing.

10. A transreflective display comprising:
a plurality of sub-pixel groupings, each said sub-pixel grouping further comprising a plurality of color sub-pixels, wherein one such said color sub-pixel is a substantially a dark color sub-pixeland wherein each said color sub-pixel comprises an optical via;
wherein said sub-pixel groupings form an array across said display in a plurality of rows and columns and wherein said dark color sub-pixels form substantially a vertical line down said display;
wherein said optical vias are formed upon said dark sub-pixels such that shift the phase of the reconstruction points of said dark sub-pixels.

11. The display as recited in claim 10 wherein said optical vias are formed upon said dark sub-pixels such that the phases of the reconstruction points are shifted in the vertical axis.

12. The display as recited in claim 10 wherein said optical vias are formed upon said dark sub-pixels such that the phases of the reconstruction points are shifted in the horizontal axis.

13. A display comprising:
a plurality of sub-pixel groupings, each said grouping further comprising a plurality of color sub-pixels, wherein at least one such said color comprises substantially a dark color;
wherein said sub-pixel groupings comprise two row and three columns of sub-pixels and further wherein said sub-pixel grouping comprises a first dark sub-pixel and a second dark sub-pixel;
further wherein said first dark sub-pixel is formed on the first row of said sub-pixel grouping and said second dark sub-pixel is formed on the second row of said sub-pixel grouping; and
further wherein said first dark sub-pixel and said second dark sub-pixel are formed on different columns of said sub-pixel grouping.

14. The display as recited in claim 1 wherein said sub-pixels are formed on said display with its length-wise edge on a horizontal axis.

15. The display as recited in claim 10 wherein said sub-pixels are formed on said display with its length-wise edge on a horizontal axis.

16. The display as recited in claim 13 wherein said sub-pixels are formed on said display with its length-wise edge on a horizontal axis.

17. A display comprising:
a plurality of rows and columns of sub-pixel arrangements, each sub-pixel arrangement ecomprising:
first, second, and third color sub-pixels, and wherein one of the color sub-pixels is substantially a dark color sub-pixel, and
wherein a spacing is formed between adjacent columns of the first and second color sub-pixels in the sub-pixel arrangements that forms a dark stripe substanitally out of phase with a dark stripe formed by the dark color sub-pixels in the sub-pixel arrangements.

18. The display as recited in claim 17, wherein the dark color sub-pixel is a split sub-pixel occupying less area than the other sub-pixels.

19. The display as recited in claim 17, wherein the first and third color sub-pixels are a red or green sub-pixel.

20. The display as recited in claim 19, wherein the first and third color sub-pixels in the sub-pixel arrangements form a checkerboard pattern.

21. The display as recited in claim 20, wherein the first, second, and third color-sub-pixels are oriented along a horizontal axis such that the substantially dark color sub-pixels form a horizontal dark stripe.
